(19) United States
(12) Patent Application Publication
(10) Pub. No.: US 2026/0238460 A1
(43) Pub. Date: Aug. 13, 2026

(54) MASTER ENCRYPTION KEY SYSTEMS AND METHODS

(71) Applicant: Smarsh Inc., PORTLAND, OR (US)

(72) Inventor: Charles Wastell, PORTLAND, OR (US)

(21) Appl. No.: 19/464,457

(22) Filed: Jan. 29, 2026

Related U.S. Application Data
(60) Provisional application No. 63/756,514, filed on Feb. 10, 2025.

(51) Int. Cl. H04L 9/08; H04L 9/40

(52) U.S. Cl. CPC H04L 9/0822; H04L 9/0894; H04L 9/40

(57) ABSTRACT

A computing system can include a hardware security module comprising a master encryption key and a computing device coupled to a key vault comprising at least one encrypted encryption key. The computing device can transmit the at least one encrypted encryption key to the hardware security module. The computing device can receive at least one decrypted encryption key from the hardware security module based on the master encryption key. The computing device can store the at least one decrypted encryption key in a cache. The computing device can periodically query the hardware security module for decryption authority. In response to receiving a denial of authority from the hardware security module, the computing device can clear the cache.

### CROSS-REFERENCE TO RELATED APPLICATION

This application claims the benefit of, and priority to, U.S. Provisional Application No. 63/756,514, filed on Feb. 10, 2025, and entitled “MASTER ENCRYPTION KEY SYSTEMS AND METHODS,” which is hereby incorporated by reference in its entirety.

### TECHNICAL FIELD

The present systems and processes relate to encryption key hierarchies.

### BACKGROUND

As digital communications and data storage expand, organizations face increasing challenges in securing sensitive information. Traditional encryption methods often rely on static keys, which, if exposed, can compromise vast amounts of data. Additionally, a single compromised key can expose an entire dataset, rather than isolating damage to specific segments. Furthermore, traditional encryption methods offer organizations little control over access to their data. Oftentimes, organizations lack the storage capacity or encryption ability to encrypt and store their own data, but desire an ability to deny access to their data if necessary.

Therefore, there is a long-felt but unresolved need for hierarchical key encryption systems that provide additional control to data sources.

### BRIEF SUMMARY OF THE DISCLOSURE

Briefly described, and according to one embodiment, aspects of the present disclosure generally relate to a hierarchical key encryption system. The disclosed system can include three “levels” of encryption keys. The “top level” can include a master encryption key stored on a hardware security module. The “middle level” can include key encryption keys stored on a key vault. The “bottom level” can include data encryption keys stored in the key vault. The system can receive data objects, which can be encrypted by the data encryption keys. The data encryption keys can be encrypted by the key encryption keys. The key encryption keys can be encrypted by the master encryption key. The source of the data objects (e.g., an entity that generates the data objects received by the system) can control access to the master key by controlling the hardware security module. Thus, the source of the data objects can deny decryption authority to system by denying access to the master key.

Each of the data encryption keys can encrypt a specific data object. The data encryption keys can be encrypted by a specific key encryption key based on when the specific data object was received by the system. Each of the key encryption keys can be associated with a predefined period of time. The system can determine when each data object was received, encrypt the data object with a data encryption key, and encrypt the data encryption key with a specific key encryption key based on when the data object was received.

The above and further features of the disclosed systems and methods will be recognized from the following detailed descriptions and drawings of various embodiments.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an encryption key hierarchy system according to various embodiments of the present disclosure.

FIG. 2 illustrates an exemplary networked environment for the disclosed system according to various embodiments of the present disclosure.

FIG. 3 illustrates an exemplary encryption process for the disclosed system according to various embodiments of the present disclosure.

FIG. 4 illustrates an exemplary key encryption key process for the disclosed system according to various embodiments of the present disclosure.

FIG. 5 illustrates an exemplary decryption authority process for the disclosed system according to various embodiments of the present disclosure.

FIG. 6 illustrates an exemplary decryption process for the disclosed system according to various embodiments of the present disclosure.

FIG. 7 illustrates an exemplary data retention policy process for the disclosed system according to various embodiments of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

Ordinal numbers (e.g., first, second, third, etc.) used solely for distinguishing between elements and do not imply any specific order, sequence, priority, or relative importance. The use of such terms is intended for clarity and convenience in describing different components, steps, or elements and should not be construed as limiting the scope of the disclosure. While a specific ordinal number may be used in the disclosure, any other ordinal number can be acceptable for the purposes of distinguishing different elements.

The foregoing disclosure discusses encryption keys, including data encryption key and key encryption keys. As will be understood by those having skill in the art, an unencrypted data encryption key and a decrypted data encryption key can be equivalent. Similarly, an unencrypted key encryption key and a decrypted key encryption key can be equivalent. In some embodiments, the unencrypted and decrypted versions can vary and provide the same cryptographic functionality.

### Exemplary Embodiments

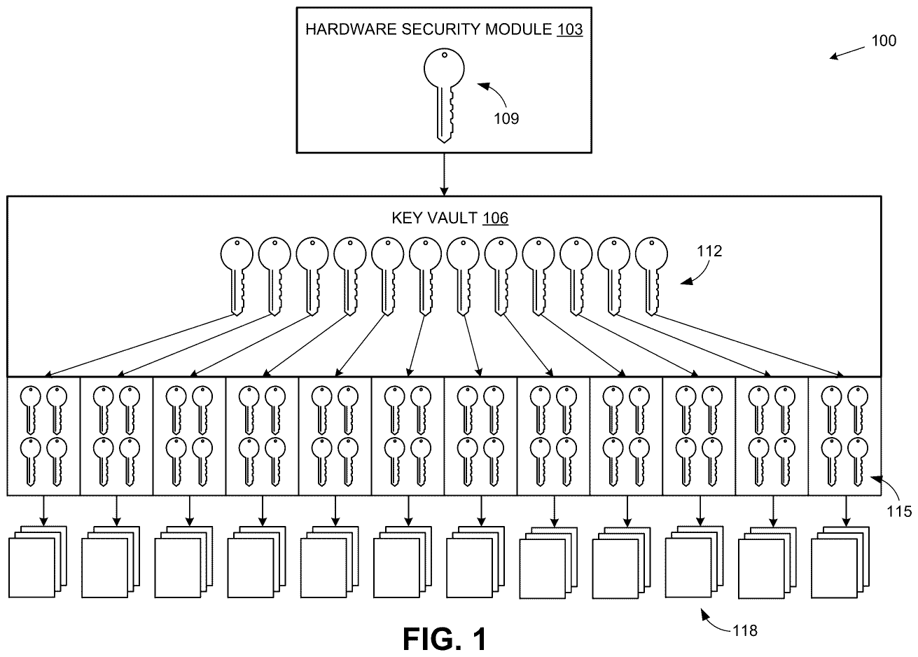

Referring now to the figures, for the purposes of example and explanation of the fundamental processes and components of the disclosed systems and processes, reference is made to FIG. 1, which illustrates the encryption key hierarchy system 100 (the “system 100”). The system 100 can include the hardware security module 103 and the key vault 106. As will be understood by those having skill in the art, the hardware security module 103 can include a computing device configured to perform cryptographic functions. Similarly, the key vault 106 can include a computing device configured to perform encryption key management. The hardware security module 103 and the key vault 106 can include any computing device capable of performing cryptographic functions, including but not limited to, Advanced Encryption Standard (AES) 256-bit encryption, Rivest-Shamir-Adleman (RSA) encryption, and Secure Sockets Layer (SSL)/Transport Layer Security (TLS) protocols. The hardware security module 103 and the key vault 106 can be in communication. For example, the hardware security module 103 and the key vault 106 can be connected over a network. As another example, the hardware security module 103 and the key vault 106 can be hosted together or arranged in a distributed computing arrangement.

The system 100 can include a master key 109, one or more key encryption keys 112, and one or more data encryption keys 115. The master key 109 can be hosted on the hardware security module 103. The key encryption keys 112 and the data encryption keys 115 can be hosted on the key vault 106. The master key 109 can encrypt any of the key encryption keys 112. The key encryption keys 112 can encrypt any of the data encryption keys 115. The data encryption keys 115 can encrypt the data objects 118 received by the system 100. The master key 109, one or more key encryption keys 112, and one or more data encryption keys 115 can form an encryption hierarchy with the master key 109 at the top, the data encryption keys 115 at the bottom, and the key encryption keys 112 located in between. The encryption hierarchy of the system 100 can prevent access to any of the resources located lower in the hierarchy without access to a resource located higher on the hierarchy. For example, when encrypted, the data objects 118 can be inaccessible without the data encryption keys 115. As another example, while encrypted, the data encryption keys 115 can be inaccessible without the key encryption keys 112. As another example, if encrypted, the key encryption keys 112 can be inaccessible without the master key 109. Data may be inaccessible by an unauthorized service when the plaintext version of the data is unavailable without decrypting the data using a cryptographic key known only to authorized services.

The hardware security module 103 can store and control access to the master key 109. The key vault 106 can query the hardware security module 103 for decryption authority. The hardware security module 103 can provide decryption authority by providing access to the master key 109. If the hardware security module 103 provides decryption authority, the master key 109 can be used to decrypt the key encryption keys 112, if encrypted. The hardware security module 103 can deny decryption authority by denying access to the master key 109. When the key encryption keys 112 are encrypted, the hardware security module 103 can prevent the decryption of the key encryption keys 112 by denying decryption authority and withholding access to keys to decrypt the key encryption keys 112.

The key vault 106 can store and control the key encryption keys 112 and the data encryption keys 115. The key encryption keys 112 can encrypt and decrypt the data encryption keys 115 and the data encryption keys 115 can encrypt and decrypt the data objects 118. The data objects 118 can be received by the system 100. The data objects 118 can include any communications (e.g., emails, text messages, direct messages from messaging, social media, and collaboration platforms, audio and video calls and messages) and any electronic files (e.g., documents, images, videos, audio, software). The system 100 can encrypt and store the data objects 118 based on a data retention policy. Each data object 118 can be encrypted by a particular data encryption key 115. Said another way, each of the data encryption keys 115 can encrypt and decrypt a specific data object 118. In some embodiments, each data encryption key 115 can encrypt multiple data objects.

Each of the data encryption keys 115 can be encrypted by a key encryption key 112 based on when the data object 118 was received by the system. Each of the key encryption keys 112 can be associated with a predefined period of time, such as, for example, a day, a week, a month, or a year. For example, the predefined period of time can include, but is not limited to, a specific day, week, month, or year. For the purposes of explanation, the system 100 illustrated by FIG. 1, the predefined period of time can include a month. For example, each of the key encryption keys 112 can be associated with a specific month in a specific year. As an example, if a data object 118 is received within a specific month of the specific year, the data object 118 can be encrypted by a specific data encryption key 115 (e.g., specific, unique, or particular to the data object 118) and the specific data encryption key 115 can be encrypted by the key encryption key 112 associated with the specific month of the specific year. If multiple data objects 118 are received within the specific month of the specific year, the associated key encryption key 112 can encrypt multiple data encryption keys 115 (e.g., one data encryption key 115 for each data object 118 received within the specific month of the specific year).

The hardware security module 103 and the key vault 106 can be controlled by a single or multiple entities (e.g., organizations, business, governments). For example, the hardware security module 103 can be controlled by the source of the data objects (e.g., entity that generates the data objects). As another example, the key vault 106 can be controlled by a service provider for the entity controlling the hardware security module 103. As a non-limiting, illustrative example, the hardware security module 103 can be controlled by a business that generates the data objects for encryption and the key vault 106 can be controlled by an encryption service provider. The entity that controls the hardware security module 103 can provide inputs to the hardware security module 103 to provide or deny decryption authority. In this embodiment, the entity can generate the data objects, which can be captured by a computing device in communication with the key vault 106. The system 100 can encrypt and store the data objects. The source of the data objects (e.g., the entity that generates the data objects) can control and/or limit access to the data objects once encrypted by providing or denying decryption authority.

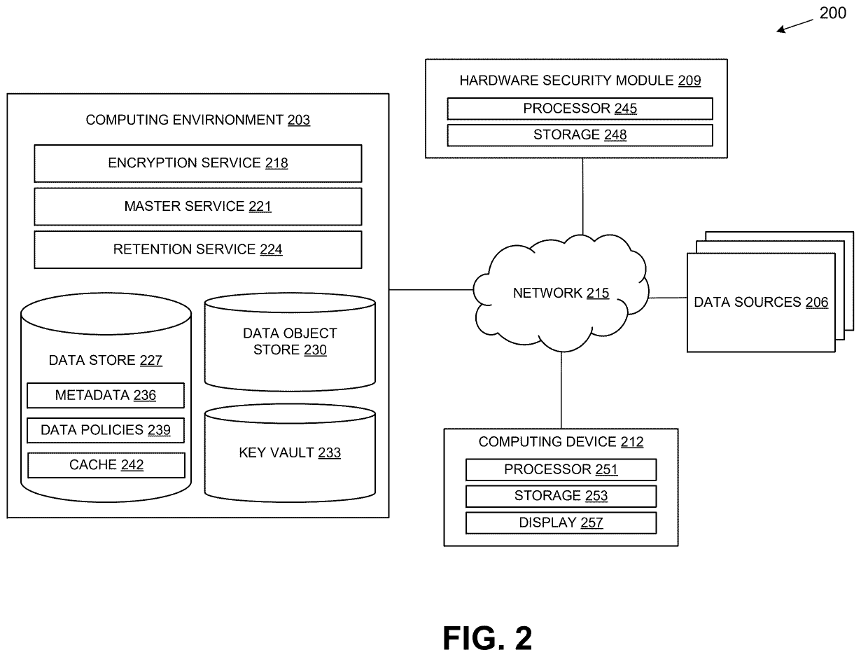

Referring now to FIG. 2, shown is an exemplary networked environment 200 for the encryption key hierarchy system according to various embodiments of the present disclosure. As will be understood and appreciated, the exemplary networked environment 200 shown in FIG. 2 represents merely one approach or embodiment of the present system, and other aspects are used according to various embodiments of the present system. Exemplary networked environment 200 can include, but is not limited to, a computing environment 203 connected to one or more data sources 206, the hardware security module 209, and the one or more computing devices 212 connected over a network 215.

The elements of the computing environment 203 can be provided via one or more computing devices that may be arranged, for example, in one or more server banks or computer banks or other arrangements. Such computing devices can be located in a single installation or may be distributed among many different geographical locations. For example, the computing environment 203 can include one or more computing devices that together may include a hosted computing resource, a grid computing resource, or any other distributed computing arrangement. In some cases, the computing environment 203 can correspond to an elastic computing resource where the allotted capacity of processing, network, storage, or other computing-related resources may vary over time. Regardless, the computing environment 203 can include one or more processors and memory having instructions stored thereon that, when executed by the one or more processors, cause the computing environment 203 to perform one, some, or all of the actions, methods, steps, or functionalities provided herein.

The computing environment 203 can include an encryption service 218, a master service 221, a retention service 224, a data store 227, a data object store 230, and key vault 233. The encryption service 218, the master service 221, and the retention service 224 can correspond to one or more software executables that can be executed by the computing environment 203 to perform the functionality described herein. While the encryption service 218, the master service 221, and the retention service 224 are described as different services, it can be appreciated that the functionality of these services can be implemented in one or more different services executed in the computing environment 203. Various data can be stored in the data store 227, including but not limited to, metadata 236, data policies 239, and cache 242.

The encryption service 218 can perform cryptographic operations on the encryption keys and data objects. The encryption service 218 can encrypt and store the encryption keys in the key vault 233. The encryption service 218 can encrypt and store the data objects in the data object store 230. Similarly, the encryption service 218 can retrieve the encrypted encryption keys from the key vault 233, decrypt the encryption keys, and store the decrypted encryption keys in the cache 242. The encryption service 218 can retrieve the encrypted data objects from the data object store 230 and return the decrypted data object. The encryption service 218 can perform the cryptographic operations using any cryptographic method, including but not limited to, AES 256-bit encryption, RSA encryption, and SSL/TLS protocols. The encryption service 218 can perform cryptographic integrity checks to verify that the decrypted encryption keys and/or data objects have not been altered or corrupted. For example, the encryption service 218 can perform hash verification or checksum validation on decrypted keys before use. For example, the cryptographic method can vary based on the encryption purpose (e.g., compliance, security).

As will be understood, the encrypted encryption keys can be stored in the key vault 233. As an example, the key vault 233 can include any number of nodes, including but not limited to, 3 nodes. Access to the key vault 233 can be recorded in a log. The decrypted encryption keys can be stored in the cache 242. The decrypted encryption keys can be used to access and decrypt the encrypted encryption keys stored in the key vault 233.

The encryption service 218 can receive the data objects from the data sources 206 via an API. The encryption service 218 can identify and/or generate metadata associated with the data objects and save the metadata 236 in the data store 227. The encryption service 218 can determine a predefined time period with the data object. The predefined time period can include a date and time that a data object was received by the encryption service 218. For example, the predefined time period can include a defined period of time (e.g., 1 minute, 1 hour, 1 day, 1 week, 1 year). The encryption service 218 can determine the predefined time period based on the metadata 236.

The master service 221 can receive decryption authority from the hardware security module 209. As will be understood, decryption authority can provide access to the decrypted key encryption keys, the decrypted data encryption keys, and the decrypted data objects. An entity associated with the data sources 206 can control access to the hardware security module 209 and can provide the decryption authority. The master service 221 can receive the decryption authority from the hardware security module 209. In some embodiments, the decryption authority can be granted based on pre-configured security policies, access control lists, or authentication procedures enforced by the hardware security module.

The master service 221 can periodically query the hardware security module 209 for decryption authority. The master service 221 can transmit a HTTP ping to the hardware security module 209 and receive a response granting decryption authority. The master service 221 can receive decryption authority based on the encryption service 218 receiving decrypted key encryption key generated by decrypting a encrypted key encryption key with the master key.

The retention service 224 can identify data policies 239 associated with the data objects. The retention service 224 can identify the data policies 239 based on the metadata 236 associated with the data object (e.g., the type of data object, the date received, associated identities). The data retention policy can include time to retain a data object in the data object store 230 and/or conditions for deleting the data object store 230. The retention service 224 can determine if a data retention policy is satisfied such that any data objects associated with the data retention policy can be deleted from the data object store 230. For example, if the data retention policy includes a time to retain a data object, the retention service 224 can determine when that time elapses and delete the data object from the data store 230. As another example, if the data retention policy includes conditions to retain the data object, the retention service 224 can determine if the conditions have been met and delete the data objects from the data store 230.

The retention service 224 can identify any encryption keys associated with the deleted data objects. For example, the retention service 224 can identify associated encryption keys and data objects based on a linking identifier or metadata 236. The retention service 224 can determine if any of the identified encryption key are associated with other data objects in the data object store 230. If the identified encryption key is not associated with other data objects in the data object store 230, the retention service 224 can delete the encryption key from the key vault 233 or the cache 242.

The data object store 230 can include a write once, read many (e.g., WORM) storage. Once a data object is saved in the data store 230, the data objects can be read (e.g., viewed, downloaded, transmitted), but may not be deleted or modified. When a specific data object is requested, the data object can be copied from the data store 230.

The key vault 233 can include a computing device configured to perform key management. The key vault 233 can store the encrypted encryption keys. For example, the key vault 233 can include an encrypted data encryption key for each data object received by the encryption service 218. As another example, the key vault 233 can include an encrypted key encryption key associated with each predefined period.

The data sources 206 can include any source as a data object. If the data objects are communications, the data sources 206 can include email services, phone services (e.g., text and audio call services), collaboration services, and messaging services. The services can be associated with the entity controlling the hardware security module 209. As another example, the data sources 206 can include file systems and/or computing directories.

The hardware security module 209 can include a computing device configured to perform cryptographic functions. The hardware security module 209 can host the master encryption key. The hardware security module 209 can receive an encrypted key encryption key from the encryption service 218 and return the decrypted key encryption key back to the encryption service 218. The hardware security module 209 can provide decryption authority to the master service 221. For example, the hardware security module 209 can deny decryption authority, which can prevent access to the encrypted encryption keys in the key vault 233.

According to various embodiments, the computing device 212 can include any device capable of accessing network 215 including, but not limited to, a computer, smartphone, tablets, or other device. The computing device 212 can include a processor 251 and storage 253. The computing device 212 can include a display 257 on which various user interfaces can be rendered to allow users to configure, monitor, control, and command various functions of networked environment 200. In various embodiments, computing device 212 can include multiple computing devices. Regardless, the computing device 212 can include one or more processors and memory having instructions stored thereon that, when executed by the one or more processors, cause the computing device 212 to perform one, some, or all of the actions, methods, steps, or functionalities provided herein.

The network 215 includes, for example, the Internet, intranets, extranets, wide area networks (WANs), local area networks (LANs), wired networks, wireless networks, or other suitable networks, etc., or any combination of two or more such networks.

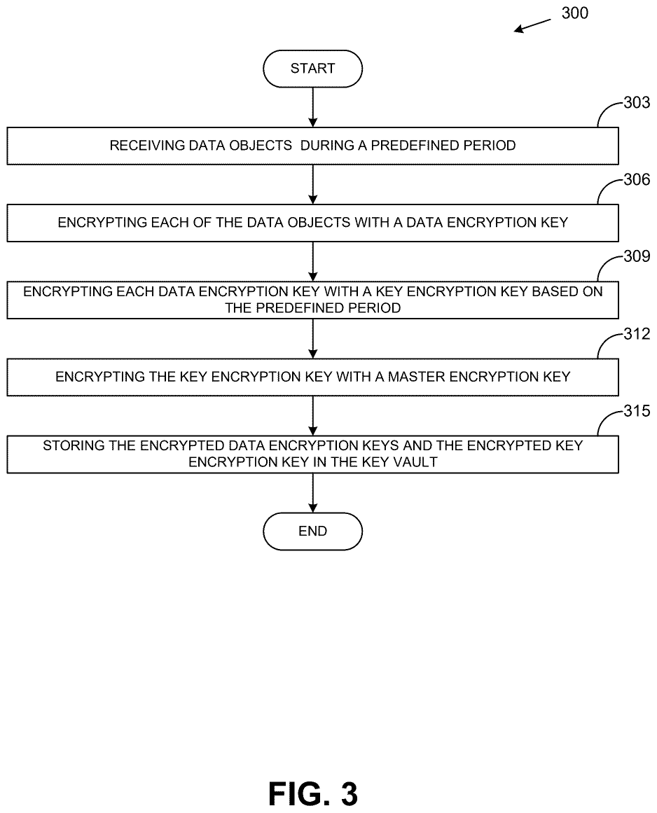

Referring now to FIG. 3, shown is an exemplary, encryption process 300 according to various embodiments of the present disclosure. As will be understood by one having ordinary skill in the art, the steps and processes shown in FIGS. 3-7 may operate concurrently and continuously, are generally asynchronous and independent, can be performed in part or in whole by a combination of one or more of the computing environment 203, the data sources 206, the hardware security module 209, and the computing device 212 and are not necessarily performed in the order shown and various steps can be executed linearly or in parallel. Process 300 can be performed entirely, partially, or in coordination with the encryption service 218, the master service 221, and the retention service 224.

At step 303, the process 300 can include receiving data objects during a predefined time period. The encryption service 218 can receive data objects from the data sources 206. The data objects can be received by the encryption service 218 from the data sources 206 via an API. The data objects can include any communications (e.g., emails, text messages, direct messages from messaging, social media, and collaboration platforms, audio and video calls and messages) and any electronic files (e.g., documents, images, videos, audio, software).

Each data object received by the encryption service 218 can be received during a predefined period of time. For example, the predefined period of time can include, but is not limited to, a specific day, week, month, or year. As an example, each predefined period of time can include a specific month during a specific year. In this example, a data object received during January 2025 can be received during a different predefined period of time than a data object received during February 2025. The predefined period of time can be determined based on the metadata associated with the data object (e.g., data received, date created, date modified). In some embodiments, the encryption service 218 can determine the predefined period of time for each data object. As will be understood by those having skill in the art, data objects can be received by the encryption service 218 at any time and different data objects can be associated with different predefined periods of time. Any metadata (e.g., dates, title, content, attachments, file data, indexing data, identity data) associated with each data object can be stored as the metadata 236.

At step 306, the process 300 can include encrypting each of the data objects with a data encryption key. The encryption service 218 can encrypt each of the data objects with a data encryption key. The encryption service 218 can use any cryptographic method, including but not limited to, AES 256-bit encryption, RSA encryption and SSL/TLS protocols. In some embodiments, each data encryption key can encrypt a single data object (e.g., each data object can be encrypted by a unique data encryption key). As an example, the system can request or generate a new data encryption key for each data object, such that the data encryption keys have a one to one relationship with data objects. In other embodiments, each data encryption key can encrypt multiple data objects. The data objects and the data encryption key can be associated based on an identifier or the metadata 236. The identifier or the metadata 236 can be used to retrieve either the data object or the data encryption key following encryption. Encrypting the data objects can generate encrypted data objects. The encrypted data objects can be stored in the data object store 230. In some embodiments, the data object store 230 can include write once, read many storage.

At step 309, the process 300 can include encrypting each data encryption key with a key encryption key based on the predefined period. The encryption service 218 can encrypt each data encryption key with a specific key encryption key that corresponds to the predefined time period/range in which the data encryption key was generated. Each of the data encryption keys can be encrypted by a key encryption key based on the predefined period associated with the data object. Each key encryption key can be associated with a specific predefined period of time. For example, each data object can be encrypted with a specific data encryption key. The specific data encryption key can be encrypted with a specific key encryption key based on when the data object was received. As a non-limiting, illustrative example, if the predefined periods are months, all of the data encryption keys used to encrypt data objects received in January 2025 can be encrypted with a specific key encryption key for January 2025. As another example, all of the data encryption keys used to encrypt data objects received in February 2025 can be encrypted with a different, specific key encryption key for February 2025. As another example, 1,000 data encryption keys used to encrypt 1,000 data objects generated in January 2025 could be encrypted with a first key encryption key, while 900 data encryption keys used to encrypt 900 data objects generated in February 2025 could be encrypted using a second key encryption key. The data encryption keys can be encrypted in response to receiving each data object with a specific predefined period. For example, the current months key encryption key can be used to encrypt all data objects generated during the current month, and when a new month starts, a new key encryption key can be generated and used for encryption data encryption keys for future data objects. As another example, the key encryption key can be selected from multiple key encryption keys based on the predefined period. Encrypting the data encryption keys can generate encrypted data encryption keys.

At step 312, the process 300 can include encrypting the key encryption key with a master encryption key. The encryption service 218 can encrypt the key encryption key with a master encryption key. The master encryption key can encrypt multiple key encryption keys. For example, the master encryption key can encrypt a key encryption key at the end of the predefined period of time associated with the key encryption key. The encryption service 218 can transmit the key encryption key to the hardware security module 209 for encryption and receive an encrypted key encryption key in response. Encrypting the key encryption keys can generate encrypted key encryption keys.

At step 315, the process 300 can include storing the encrypted data encryption keys and the encrypted key encryption keys in the key vault. The encryption service 218 can store each of the encrypted data encryption keys and the encrypted key encryption keys in the key vault 233. Any of the encrypted encryption keys (e.g., data encryption keys and key encryption keys) can be stored in the key vault 233. As will be understood, the master key may not be stored in the key vault 233.

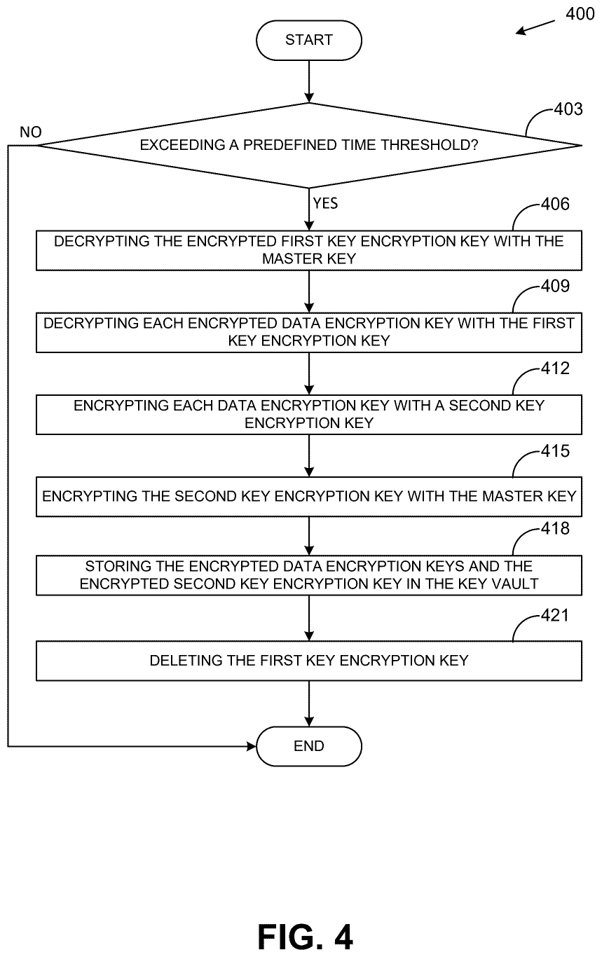

Referring now to FIG. 4, shown is a key encryption key process 400 according to various embodiments of the present disclosure. Process 400 can be performed entirely, partially, or in coordination with the encryption service 218, the master service 221, and the retention service 224. As will be understood, the process 400 can include an optional process for generating new key encryption keys. At step 403, the process 400 can include determining if a predefined time threshold has been exceeded. The encryption service 218 can determine if a predefined time threshold has been exceeded. A time threshold can be initiated at the end of each predefined period associated with each key encryption key. The predefined time threshold can include, but is not limited to, a day, a week, a month, a year, or multiple years. As a non-limiting, illustrative example, the predefined period associated with each key encryption key can include a month and each predefined time threshold can include 11 months. In this example, if the predefined period is January 2025, then the predefined time threshold can be exceeded at the beginning of January 2026. In this example, January 2025 can be a first predefined period and January 2026 can be a second predefined period separated by a predefined time threshold. If the time threshold is exceeded, the process 400 can proceed to step 406. If the time threshold is not exceeded, the process 400 can end or the step 403 can repeat until the time threshold is exceeded.

At step 406, the process 400 can include decrypting an encrypted key encryption key with the master key. The encryption service 218 can decrypt an encrypted key encryption key with the master key. For example, the encrypted key encryption key can include an encrypted first key encryption key associated with a first predefined period. The encryption service 218 can transmit the encrypted key encryption key to the hardware security module 209 for decryption and receive a decrypted key encryption key in response. As will be understood, the decrypted key encryption key can include the key encryption key prior to encryption. The decrypted key encryption key can be stored in the cache 242.

At step 409, the process 400 can include decrypting each encrypted data encryption key with the first key encryption key. The encryption service 218 can decrypt each data encryption key with the first key encryption key. As will be understood, the first key encryption key can include the key encryption key decrypted at the step 406. Decrypting the encrypted data encryption keys can generate the data encryption keys. The data encryption keys can be stored in the cache 242.

At step 412, the process 400 can include encrypting each data encryption key with a second key encryption key. The encryption service 218 can encrypt each data encryption key with a second key encryption key. The second key encryption key can be associated with the predefined period of time that began after the predefined time threshold. The data encryption keys can be encrypted with a key encryption key based on the passing of time. Encrypting the data encryption keys can generate encrypted data encryption keys.

At step 415, the process 400 can include encrypting the second key encryption key with the master key. The encryption service 218 can encrypt the second key encryption key with the master key. The encryption service 218 can transmit the second key encryption key to the hardware security module 209 for encryption and receive an encrypted second key encryption key in response. Encrypting the key encryption keys can generate encrypted key encryption keys.

At step 418 the process 400 can include storing the encrypted data encryption keys and the encrypted key encryption keys in the key vault. The encryption service 218 can store each of the encrypted data encryption keys and the encrypted key encryption keys in the key vault 233. At step 421, the process 400 can include deleting the first key encryption key from the key vault. The encryption service 218 can delete the first key encryption key from the key vault 233. As will be understood, at the end of the process 400, none of the data encryption keys may be encrypted with the first key encryption key. Any of the data encryption keys initially encrypted by the first key encryption key may be encrypted with the second key encryption key at the end of the process 400.

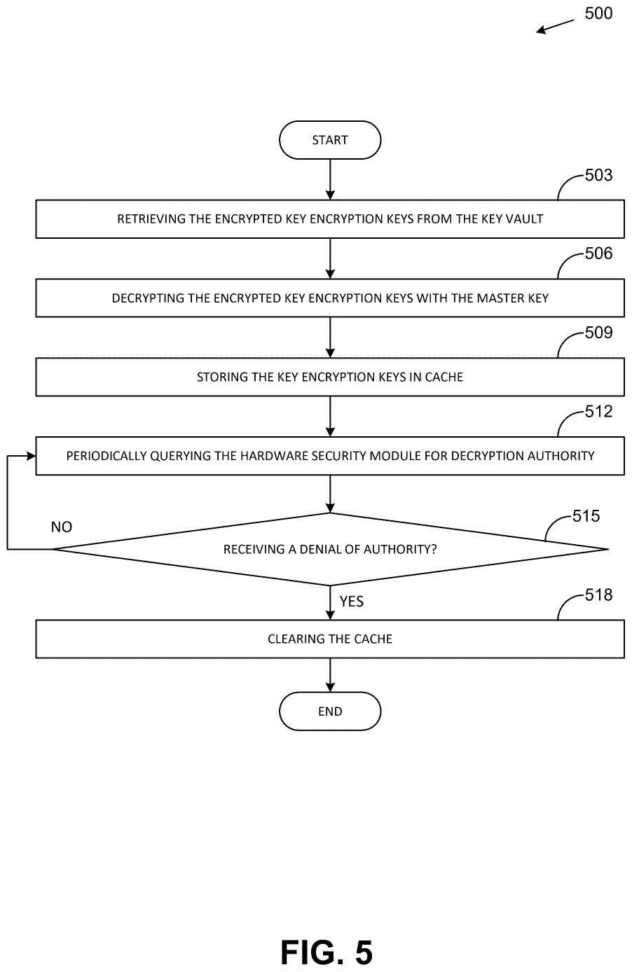

Referring now to FIG. 5, shown is a decryption authority process 500 according to various embodiments of the present disclosure. Process 500 can be performed entirely, partially, or in coordination with the encryption service 218, the master service 221, and the retention service 224. At step 503, the process 500 can include retrieving the encrypted key encryption keys from the key vault. The encryption service 218 can retrieve the encrypted key encryption keys from the key vault 233. The encrypted key encryption keys can be retrieved from the key vault 233 in response to receiving decryption authority from the hardware security module. As will be understood, decryption authority can provide access to the decrypted key encryption keys, the decrypted data encryption keys, and the decrypted data objects. An entity associated with the data sources 206 can control access to the hardware security module 209 and can provide the decryption authority. The master service 221 can receive the decryption authority from the hardware security module 209. In some embodiments, the decryption authority can be granted based on pre-configured security policies, access control lists, or authentication procedures enforced by the hardware security module.

At step 506, the process 500 can include decrypting the encrypted key encryption keys with the master key. The encryption service 218 can decrypt the encrypted key encryption keys with the master key. The encryption service 218 can transmit the encrypted key encryption key to the hardware security module 209 for decryption. The hardware security module 209 can decrypt the key encryption key with the master key and transmit the decrypted key encryption key in response to the encryption service 218. As will be understood, the decrypted key encryption key can include the key encryption key.

At step 509, the process 500 can include storing the key encryption keys in cache. The encryption service 218 can store the key encryption key in the cache 242. The cache 242 can include a first in, first out cache. The keys stored in the cache 242 can be accessible for decrypting other keys and/or data objects.

At step 512, the process 500 can include periodically querying the hardware security module for decryption authority. The master service 221 can periodically query the hardware security module 209 for decryption authority. Querying the hardware security module 209 can include the master service 221 transmitting a HTTP ping to the hardware security module 209. Querying periodically can include querying every second, every minute, every hour, or every day. The master service 221 can query the hardware security module 209 once every time period for any period (e.g., one second, one minute, one hour).

At step 515, the process 500 can include receiving a denial of authority. The master service 221 can receive a denial of authority from the hardware security module 209. The denial can be transmitted from the hardware security module 209 to the master service 221. In some other embodiments, the denial can include the hardware security module 209 denying decryption for any encrypted keys. The denial can include a denial of decryption authority. For example, an entity associated with the data sources 206 can withdraw or terminate the decryption authority by providing inputs to the hardware security module 209. Denial of authority can prevent the decryption of any encrypted keys stored in the key vault 233 and the decryption of encrypted data objects in the data store 230. Denial of authority can include denying access to the master key. In some embodiments, the denial message can include additional metadata, such as timestamps, revocation reasons, and required actions for reauthorization.

In some embodiments, after receiving the denial of authority, the master service 221 can start a timer. The timer can include any amount of time (e.g., 30 seconds, 1 minute, 10 minutes, 30 minutes). If the master service 221 receives the decryption authority from the hardware security module 209 during the timer, the process 500 can return to the step 512. If the master service 221 does not start a timer or does not receive the decryption authority during the timer, the process 500 can proceed to the step 518. If the master service 221 does not receive the denial of authority, the process 500 can return to the step 512.

At step 518, the process 500 can include clearing the cache. The master service 221 can clear the cache 242. Clearing the cache 242 can include deleting any decrypted keys stored in the cache 242, including any key encryption keys. Clearing the cache 242 can terminate access to the key vault 233. For example, access to the key vault 233 can require a key encryption key (e.g., a decrypted key encryption key stored in the cache 242). Once the key encryption key is deleted from the cache 242, access to the key vault 233 can be terminated. Clearing the cache 242 can terminate access to any encrypted data objects stored in the data object store 230.

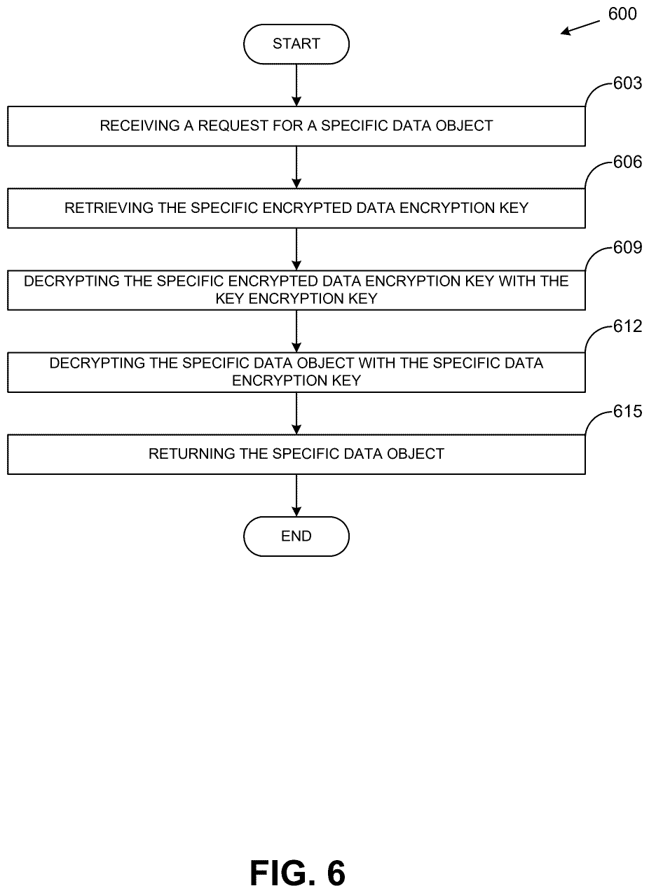

Referring now to FIG. 6, shown is a decryption process 600 according to various embodiments of the present disclosure. Process 600 can be performed entirely, partially, or in coordination with the encryption service 218, the master service 221, and the retention service 224. At step 603, the process 600 can include receiving a request for a specific data object. The encryption service 218 can receive a request for a specific data object. The request can be received from the computing device 212 via an input, from the data sources 206, or from the hardware security module 209. The request can be for an individual data object or for multiple data objects. The request can be based on metadata 236 associated with the data objects. For example, the request can be for all data objects generated on a specific date.

At step 606, the process 600 can include retrieving a specific encrypted data encryption key. The encryption service 218 can retrieve the specific data encryption key from the key vault 233. The data encryption key can be associated with the data object requested at the step 603 based on an identifier.

At step 609, the process 600 can include decrypting the specific data encryption key with the key encryption key. The encryption service 218 can decrypt the specific data encryption key with the key encryption key. The encryption service 218 can decrypt the specific data encryption key with a key encryption key stored in the cache 242. The encryption service 218 can decrypt the specific data encryption key with the specific key encryption key used to encrypt the specific data key encryption key. For example, if a specific key encryption key was used to encrypt the specific data key encryption key based on a predefined period of a data object, the specific key encryption key can decrypt the specific data encryption key. Decrypting the specific data encryption key can generate a specific decrypted data encryption key, which can include the data encryption key.

At the step 612, the process 600 can include decrypting the specific data object with the specific data encryption key. The encryption service 218 can decrypt the specific data object with the specific data encryption key. The encryption service 218 can decrypt the specific data object with the specific data encryption key to generate a specific decrypted data object. The specific decrypted data object can include the data object received at the step 303.

At the step 615, the process 600 can include returning the specific data object. The encryption service 218 can return the specific data object. The encryption service 218 can return the specific data object in the same method that the request was received at the step 603 (e.g., from the computing device 212 via an input, from the data sources 206, or from the hardware security module 209). In some embodiments, the specific data object can be returned the same as received at the step 303.

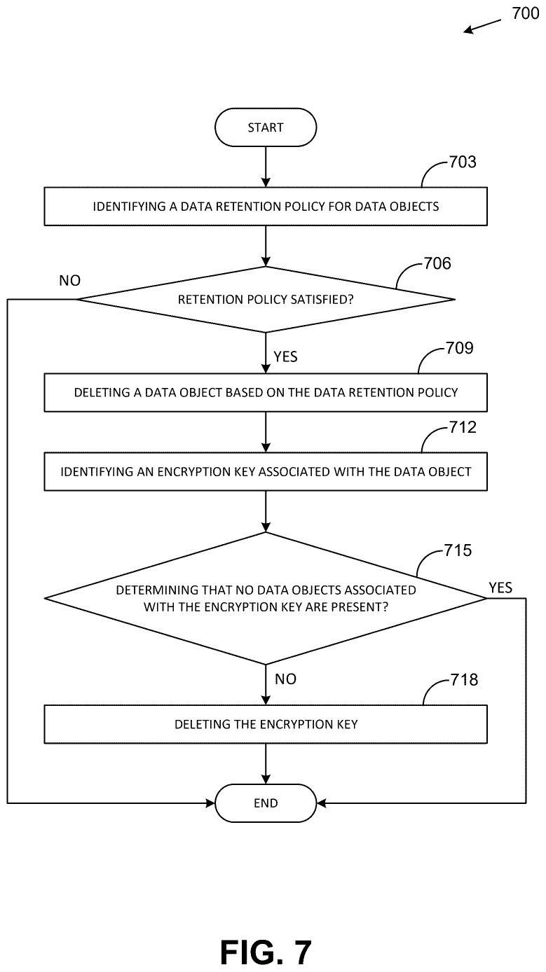

Referring now to FIG. 7, shown is a data retention process 700 according to various embodiments of the present disclosure. Process 700 can be performed entirely, partially, or in coordination with the encryption service 218, the master service 221, and the retention service 224. At step 703, the process 700 can include identifying a data retention policy for the data objects. The retention service 224 can identify a data retention policy for the data objects. The data retention policy can include the data policies 239. The retention service 224 can identify a data retention policy for the data objects when the data objects are received at the step 303. The data retention policy can be identified based on the metadata associated with the data object. The data retention policy can include time to retain a data object in the data object store 230 and/or conditions for deleting the data object store 230.

At step 706, the process 700 can include determining if the retention policy as satisfied. The retention service 224 can determine if the retention policy is satisfied. For example, if the retention policy includes a time to retain a data object, the retention service 224 can determine that the policy is satisfied once the time elapsed. As another example, if the retention policy includes a condition for retaining the data object, the retention service 224 can determine that the policy is satisfied once the condition is met. If the retention policy is satisfied, the process 700 can proceed to the step 709. If the retention policy is not satisfied, the process 700 can end or repeat the step 706.

At step 709, the process 700 can include deleting a data object based on the data retention policy. The retention service 224 can delete the data object based on the data retention policy. Deleting the data object can include deleting the data object from the data object store 230. The data object can be decrypted before deletion or be deleted while encrypted.

At step 712, the process 700 can include identifying an encryption key associated with the data object. The retention service 224 can identifying an encryption key associated with the data object. The encryption key can include a data encryption key or a key encryption key. The encryption key can be identified as associated with the data object based on an identifier shared between the encryption key and the data object or based on the metadata 236.

At step 715, the process 700 can include determining that no data objects associated with the encryption key are present. The retention service 224 can determine that no data objects associated with the encryption key are present. For example, if the encryption key includes a key encryption key, the encryption key can be associated with multiple data objects. The data objects can be identified as associated with the encryption key based on an identifier shared between the encryption key and the data object or based on the metadata 236. If no associated data objects are present in the data object store 230, the process 700 can end. If one or more data objects are present in the data object store 230, the process 700 can proceed to the step 718.

At step 718, the process 700 can include deleting the encryption key. The retention service 224 can delete the encryption key. Deleting the encryption key from the key vault 233 or the cache 242. The encryption key can be decrypted before deletion or be deleted while encrypted.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein. While thresholds are discussed herein as being met when the threshold is exceeded, the system may determine a threshold is met when a value meets or exceeds the threshold.

Clause 1. A system, comprising: a hardware security module comprising a master encryption key; and at least one computing device communicatively coupled to a key vault comprising at least one encrypted encryption key, the at least one computing device being configured to: transmit the at least one encrypted encryption key to the hardware security module; receive at least one decrypted encryption key from the hardware security module based on the master encryption key; store the at least one decrypted encryption key in a cache; periodically query the hardware security module for decryption authority; in response to receiving a denial of authority from the hardware security module: clear the cache; and terminate access to the key vault.

Clause 2. The system of clause 1, wherein the at least one encrypted encryption key is generated by encrypting at least one first encryption key with the master encryption key.

Clause 3. The system of clause 2 or any other clause herein, wherein the at least one computing device is further configured to: receive a plurality of data objects.

Clause 4. The system of clause 3 or any other clause herein, wherein the at least one computing device is further configured to: encrypt each of the plurality of data objects with a respective second encryption key of a plurality of second encryption keys to generate a plurality of encrypted data objects; and encrypt each of the plurality of second encryption keys with at least one first encryption key.

Clause 5. The system of clause 3 or any other clause herein, wherein terminating access to the key vault terminates access the plurality of data objects associated with the decryption authority.

Clause 6. The system of clause 3 or any other clause herein, wherein the plurality of data objects is received via an application program interface.

Clause 7. The system of clause 3 or any other clause herein, wherein a source of the plurality of data objects is configured to control the hardware security module.

Clause 8. The system of clause 7 or any other clause herein, wherein the source of the plurality of data objects can provide the decryption authority and denial of authority.

Clause 9. The system of clause 2 or any other clause herein, wherein the at least one first encryption key comprises the at least one decrypted encryption key.

Clause 10. A method, comprising: transmitting, via one of one or more computing devices, at least one encrypted encryption key to a hardware security module comprising a master encryption key; receiving, via one of the one or more computing devices, at least one decrypted encryption key from the hardware security module based on the master encryption key; storing, via one of the one or more computing devices, the at least one decrypted encryption key in a cache; periodically querying, via one of the one or more computing devices, the hardware security module for decryption authority; in response to receiving a denial of authority from the hardware security module: clearing, via one of the one or more computing devices, the cache; and terminating, via one of the one or more computing devices, access a key vault

Clause 11. The method of clause 10 or any other clause herein, wherein the key vault comprises the at least one encrypted encryption key and each of the at least one encrypted encryption key is associated with a predefined period of time.

Clause 12. The method of clause 11 or any other clause herein, wherein the predefined period of time is a month.

Clause 13. The method of clause 11 or any other clause herein, further comprising: encrypting, via one of the one or more computing devices, a data object with the at least one encrypted encryption key.

Clause 14. The method of clause 13 or any other clause herein, further comprising: selecting, via one of the one or more computing devices, a respective one of the at least one encrypted encryption keys based on a date associated with the data object.

Clause 15. The method of clause 13 or any other clause herein, wherein a source of the data object is configured to control access to the master encryption key.

Clause 16. A non-transitory computer-readable medium embodying a program that, when executed by at least one computing device, cause the at least one computing device to: transmit at least one encrypted encryption key to a hardware security module comprising a master encryption key; receive at least one decrypted encryption key from the hardware security module based on the master encryption key; store the at least one decrypted encryption key in a cache; periodically query the hardware security module for decryption authority; in response to receiving a denial of authority from the hardware security module: clear the cache; and terminate access to a key vault.

Clause 17. The non-transitory computer-readable medium of clause 16 or any other clause herein, wherein periodically querying the hardware security module comprises transmitting a HTTP ping the hardware security module once a minute.

Clause 18. The non-transitory computer-readable medium of clause 16 or any other clause herein, wherein the cache comprises a first in, first out cache.

Clause 19. The non-transitory computer-readable medium of clause 16 or any other clause herein, wherein the cache is cleared at least ten minutes after receiving the denial of authority.

Clause 20. The non-transitory computer-readable medium of clause 16 or any other clause herein, wherein the at least one decrypted encryption key comprises a decrypted version of the at least one encrypted encryption key.

These and other aspects, features, and benefits of the claims will become apparent from the detailed written description of the aforementioned aspects taken in conjunction with the accompanying drawings, although variations and modifications thereto may be effected without departing from the spirit and scope of the novel concepts of the disclosure.

What is claimed is:

1. A system, comprising:
a hardware security module comprising a master encryption key; and
at least one computing device communicatively coupled to a key vault comprising at least one encrypted encryption key, the at least one computing device being configured to:
transmit the at least one encrypted encryption key to the hardware security module;
receive at least one decrypted encryption key from the hardware security module based on the master encryption key;
store the at least one decrypted encryption key in a cache;
periodically query the hardware security module for decryption authority;
in response to receiving a denial of authority from the hardware security module:
clear the cache; and
terminate access to the key vault.

2. The system of claim 1, wherein the at least one encrypted encryption key is generated by encrypting at least one first encryption key with the master encryption key.

3. The system of claim 2, wherein the at least one computing device is further configured to:
receive a plurality of data objects.

4. The system of claim 3, wherein the at least one computing device is further configured to:
encrypt each of the plurality of data objects with a respective second encryption key of a plurality of second encryption keys to generate a plurality of encrypted data objects; and
encrypt each of the plurality of second encryption keys with at least one first encryption key.

5. The system of claim 3, wherein terminating access to the key vault terminates access the plurality of data objects associated with the decryption authority.

6. The system of claim 3, wherein the plurality of data objects is received via an application program interface.

7. The system of claim 3, wherein a source of the plurality of data objects is configured to control the hardware security module.

8. The system of claim 7, wherein the source of the plurality of data objects can provide the decryption authority and denial of authority.

9. The system of claim 2, wherein the at least one first encryption key comprises the at least one decrypted encryption key.

10. A method, comprising:
transmitting, via one of one or more computing devices, at least one encrypted encryption key to a hardware security module comprising a master encryption key;
receiving, via one of the one or more computing devices, at least one decrypted encryption key from the hardware security module based on the master encryption key;
storing, via one of the one or more computing devices, the at least one decrypted encryption key in a cache;
periodically querying, via one of the one or more computing devices, the hardware security module for decryption authority;
in response to receiving a denial of authority from the hardware security module:
clearing, via one of the one or more computing devices, the cache; and
terminating, via one of the one or more computing devices, access a key vault.

11. The method of claim 10, wherein the key vault comprises the at least one encrypted encryption key and each of the at least one encrypted encryption key is associated with a predefined period of time.

12. The method of claim 11, wherein the predefined period of time is a month.

13. The method of claim 11, further comprising:
encrypting, via one of the one or more computing devices, a data object with the at least one encrypted encryption key.

14. The method of claim 13, further comprising:
selecting, via one of the one or more computing devices, a respective one of the at least one encrypted encryption keys based on a date associated with the data object.

15. The method of claim 13, wherein a source of the data object is configured to control access to the master encryption key.

16. A non-transitory computer-readable medium embodying a program that, when executed by at least one computing device, cause the at least one computing device to:
transmit at least one encrypted encryption key to a hardware security module comprising a master encryption key;
receive at least one decrypted encryption key from the hardware security module based on the master encryption key;
store the at least one decrypted encryption key in a cache;
periodically query the hardware security module for decryption authority;
in response to receiving a denial of authority from the hardware security module:
clear the cache; and
terminate access to a key vault.

17. The non-transitory computer-readable medium of claim 16, wherein periodically querying the hardware security module comprises transmitting a HTTP ping the hardware security module once a minute.

18. The non-transitory computer-readable medium of claim 16, wherein the cache comprises a first in, first out cache.

19. The non-transitory computer-readable medium of claim 16, wherein the cache is cleared at least ten minutes after receiving the denial of authority.

20. The non-transitory computer-readable medium of claim 16, wherein the at least one decrypted encryption key comprises a decrypted version of the at least one encrypted encryption key.
